(19) United States
(12) Patent Application Publication
(10) Pub. No.: US 2023/0333550 A1
(43) Pub. Date: Oct. 19, 2023

(54) REMOTE OPERATION SYSTEM, REMOTE OPERATION METHOD, AND STORAGE MEDIUM

(71) Applicant: TOYOTA JIDOSHA KABUSHIKI KAISHA, Toyota-shi (JP)

(72) Inventor: Yuka IWANAGA, Toyokawa-shi (JP)

(73) Assignee: TOYOTA JIDOSHA KABUSHIKI KAISHA, Toyota-shi (JP)

(21) Appl. No.: 18/163,453

(22) Filed: Feb. 2, 2023

(30) Foreign Application Priority Data
Apr. 13, 2022 (JP) 2022-066224

(51) Int. Cl. G05D 1/00

(52) U.S. Cl. CPC G05D 1/0038; G05D 1/0016; G05D 1/0061

(57) ABSTRACT

The remote operation system includes an operation terminal. The operation terminal generates a display image based at least on the instruction proposal information and the position of the robot in response to receiving the instruction proposal information proposing an instruction of the operation of the robot from the monitoring terminal positioned within the predetermined range with respect to the robot, displays the display image, and transmits the instruction information to the robot in response to receiving the input of the instruction information for instructing the robot about the operation from the operator.

### CROSS-REFERENCE TO RELATED APPLICATION

This application claims priority to Japanese Patent Application No. 2022-066224 filed on Apr. 13, 2022, incorporated herein by reference in its entirety.

### BACKGROUND

### 1. Technical Field

The present disclosure relates to a remote operation system, a remote operation method, and a storage medium, and more particularly, to a remote operation system, a remote operation method, and a storage medium for remotely operating a robot.

### 2. Description of Related Art

In recent years, a method for an operator to appropriately remotely operate a robot for work has been proposed. For example, Japanese Unexamined Patent Application Publication No. 2021-160072 (JP 2021-160072 A) discloses a robot control system that, in a remote operation system of a robot, specifies a required work for an object to be worked by the robot based on a captured image obtained by photographing a workplace by the robot, and transmits information of the work to an operator.

### SUMMARY

In the system described in JP 2021-160072 A, the robot is limited to performing an operation within a range that the system can assume or recognize, for example, an operation within a field of view of the robot, or an operation within a range that the operator can visually recognize from a remote place through a screen. Therefore, the robot cannot operate in consideration of an unexpected or unrecognized situation of the system, particularly an unexpected or unrecognized situation of the operator.

In view of the above issue, an object of the present disclosure is to provide a remote operation system, a remote operation method, and a storage medium that allow a robot to operate in consideration of an unexpected or unrecognized situation of a system.

A remote operation system according to an aspect of the present disclosure includes an operation terminal. The operation terminal: generates a display image at least based on instruction proposal information and a position of a robot in response to receiving the instruction proposal information from a monitoring terminal located in a predetermined range based on the robot, the instruction proposal information being information for proposing an instruction of operation of the robot; displays the display image; and transmits instruction information to the robot in response to receiving an input of the instruction information from an operator, the instruction information being information for instructing the robot about the operation. As a result, the operator can instruct the robot to perform an operation upon assuming or recognizing a situation that the system cannot assume or recognize.

In the above-described remote operation system, the operation terminal may: superimpose and display, on the display image, an option on whether to adopt a proposal indicated by the instruction proposal information; receive a selection on whether to adopt the instruction proposal information; and transmit the instruction information corresponding to the selection to the robot. Since the operator only needs to select whether to adopt the proposal, instructions can be executed quickly.

In addition, the remote operation system may further include the monitoring terminal. In response to receiving, from a monitoring person, an input of a handwritten input image with respect to an image indicating a surrounding environment of the robot, the monitoring terminal may generate the instruction proposal information based on the handwritten input image and transmit the instruction proposal information to the operation terminal. Thus, the monitoring person can easily give the instruction proposal in real time. Further, since the proposed instruction is not limited to a predetermined content, the monitoring person can propose a dynamic and flexible instruction.

The remote operation system may further include the robot. The robot may include a normal mode and an intervention mode as an operation mode, a normal mode being a mode in which the robot operates based on the instruction information received from the operation terminal, and the intervention mode being a mode in which the robot operates based on an operation plan generated by the robot or the instruction information received from the monitoring terminal. The robot may switch the operation mode from the normal mode to the intervention mode when the robot does not receive the instruction information from the operation terminal within a predetermined time after the monitoring terminal transmits the instruction proposal information. Thus, even when the operator is not aware of the instruction proposal or the operator takes time to make a decision, danger can be avoided by flexibly taking measures at the site.

In the above remote operation system, in response to receiving an input of the instruction information from a monitoring person in the intervention mode, the monitoring terminal may transmit the instruction information to the robot. Thus, the monitoring person at the site can flexibly take measures to avoid the danger.

In the above remote operation system, the operation terminal may superimpose and display mode information on the display image in response to switching of the robot to the intervention mode. Thus, the operator can immediately recognize that the robot has shifted to the intervention mode.

A remote operation method according to an aspect of the present disclosure includes: generating a display image at least based on instruction proposal information and a position of a robot in response to receiving the instruction proposal information from a monitoring terminal located in a predetermined range based on the robot, the instruction proposal information being information for proposing an instruction of operation of the robot; displaying the display image; and transmitting instruction information to the robot in response to receiving an input of the instruction information from an operator, the instruction information being information for instructing the robot about the operation. As a result, the operator can instruct the robot to perform an operation upon assuming or recognizing a situation that the system cannot assume or recognize.

In a storage medium storing a program according to an aspect of the present disclosure, the program causes a computer to achieve: generating a display image at least based on instruction proposal information and a position of a robot in response to receiving the instruction proposal information from a monitoring terminal located in a predetermined range based on the robot, the instruction proposal information being information for proposing an instruction of operation of the robot; displaying the display image; and transmitting instruction information to the robot in response to receiving an input of the instruction information from an operator, the instruction information being information for instructing the robot about the operation. As a result, the operator can instruct the robot to perform an operation upon assuming or recognizing a situation that the system cannot assume or recognize.

The present disclosure can provide a remote operation system, a remote operation method, and a storage medium that allow a robot to operate in consideration of an unexpected or unrecognized situation of a system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a remote operation system according to the present embodiment;

FIG. 2 is a diagram illustrating a usage state of the remote operation system according to the present embodiment;

FIG. 3 is an external perspective view illustrating an external configuration example of the robot according to the present embodiment;

FIG. 4 is a block diagram illustrating a functional configuration of the robot according to the present embodiment;

FIG. 5 is a flowchart illustrating an example of the operation of the robot according to the present embodiment;

FIG. 6 is a flowchart illustrating an example of the operation of the robot according to the present embodiment;

FIG. 7 is a block diagram showing the functional constitution of the monitoring terminal concerning this embodiment

FIG. 8 is a flowchart illustrating an example of an operation of the monitoring terminal according to the present embodiment;

FIG. 9 is a diagram illustrating an example of a handwritten input image according to the present embodiment;

FIG. 10 is a block diagram illustrating a functional configuration of an operation terminal according to the present embodiment;

FIG. 11 is a flowchart illustrating an example of an operation of the operation terminal according to the present embodiment;

FIG. 12 is a diagram illustrating an example of a display of a display unit according to the present embodiment;

FIG. 13 is a flowchart illustrating an example of the operation of the robot according to the first modification of the present embodiment; and

FIG. 14 is a flow chart illustrating an example of the operation of the robot according to the second modification of the embodiment.

### DETAILED DESCRIPTION OF EMBODIMENTS

Hereinafter, embodiments of the present disclosure will be described in detail with reference to the drawings. In the drawings, the same or corresponding elements are denoted by the same reference numerals, and redundant descriptions are omitted as necessary for clarity of description.

### Embodiment 1

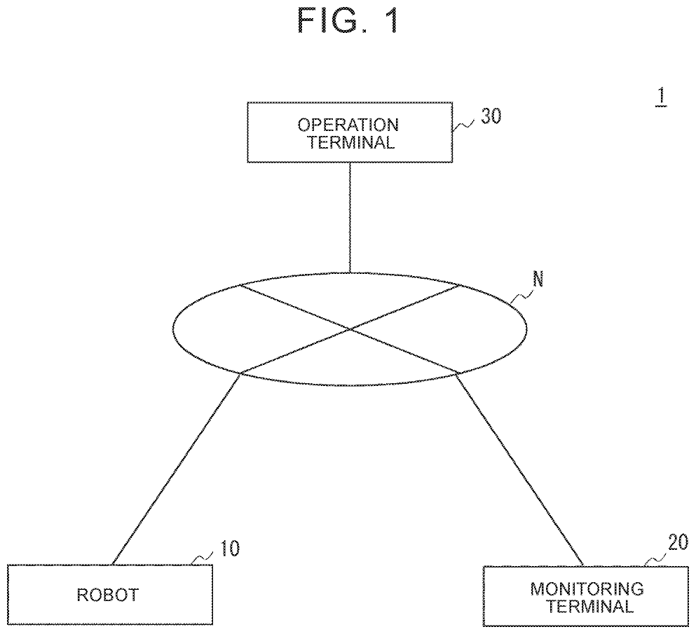

First, Embodiment 1 of the present disclosure will be described. FIG. 1 is a block diagram illustrating a configuration of a remote operation system 1 according to the present embodiment. The remote operation system 1 is a computer system for remotely operating a robot.

The remote operation system 1 includes a robot 10, a monitoring terminal 20, and an operation terminal 30, which are configured to be able to communicate with each other via a network N.

The network N is a wired or wireless network. The network N may be at least one of Local Area Network (LAN), Wide Area Network (WAN), the Internet and the like, or a combination thereof.

The robot 10 is an example of a moving object to be remotely operated by the operation terminal 30. The robot 10 periodically transmits its own position information and sensing data of a sensor mounted on the robot via the network N to the operation terminal 30. Then, the robot 10 receives an instruction from the operation terminal 30 via the network N and operates in accordance with the instruction. The robot 10 is configured to be able to operate autonomously depending on the operation mode.

The monitoring terminal 20 is a terminal device located around the robot 10. In the present embodiment, the monitoring terminal 20 is a terminal device carried and used by a monitor located around the robot 10. The position around the robot 10 may be a position within a predetermined range with respect to the robot 10. The monitoring terminal 20 is, for example, a smartphone or a tablet terminal having a touch panel.

The monitoring person using the monitoring terminal 20 grasps the situation around the robot with a field of view different from that of the robot 10. That is, the monitoring person can grasp a dynamic environmental change or a situation in a range that the robot 10 cannot recognize by a sensor or the like. The monitoring person proposes an operation to be instructed to the robot 10 to the operation terminal 30 by using the monitoring terminal 20 in accordance with the situation around the robot 10. In the following, information related to the proposal of the instructions for the operation of the robot 10 is referred to as the instruction proposal information.

The operation terminal 30 is a terminal device that is used by an operator and issues an instruction for remotely operating the robot 10. The operation terminal 30 is a personal computer, a smartphone, or a tablet terminal. The operation terminal 30 receives the position information and the sensing data of the robot 10, and displays an environment within a range that can be recognized by the robot 10 on a display unit (not shown) based on the position information, the sensing data, and the map information. Then, the operator who has viewed the display instructs the robot 10 about the operation of the robot 10 using the operation terminal 30. Accordingly, the operator can appropriately instruct the operation of the robot 10 based on the information within the range that can be recognized by the robot 10. In the following description, information for instructing the robot about the operation is referred to as instruction information.

When the instruction proposal information is received from the monitoring terminal 20, the operation terminal 30 visually displays the instruction proposal information on the display unit. Then, the operator who has viewed the display transmits instruction information regarding the operation of the robot 10 to the robot 10 using the operation terminal 30. As a result, the operator can dynamically and flexibly instruct the operation of the robot 10 based on the information of the range that the robot 10 cannot recognize.

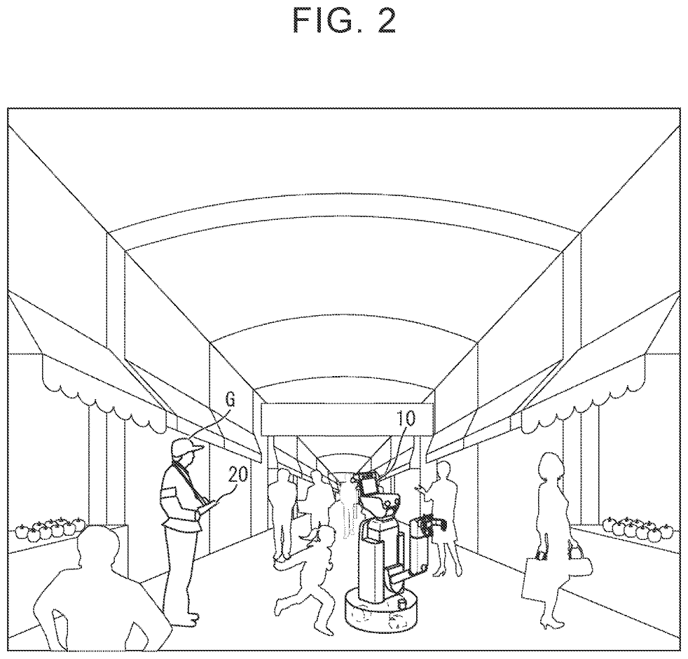

FIG. 2 is a diagram illustrating a usage state of the remote operation system 1 according to the present embodiment. For example, the robot 10 is used to introduce a shop to a passer in a shopping mall or to support the transportation of a baggage by the passer. The operator can talk with the passer through the display screen of the robot 10.

A monitoring person G is provided around the robot 10 and monitors the situation around the robot 10 while looking at the situation. For example, when the monitoring person G recognizes that a plurality of passers are approaching from the front, which is outside the field of view of the robot 10, the monitoring person G manually inputs information indicating that the robot 10 should move to the right to the monitoring terminal 20. The handwriting may be by drawing a line with a touch pen or the like, or may be by arranging a stamp indicating the content of the instruction at a position designated by the monitoring person G.

Further, for example, when the robot 10 moves the arm and it is expected that the arm hits a small child passing nearby, the monitoring person G manually inputs information indicating that the arm operation of the robot 10 should be prohibited to the monitoring terminal 20.

Upon receiving the input, the monitoring terminal 20 transmits instruction proposal information corresponding to the input information to the operation terminal 30.

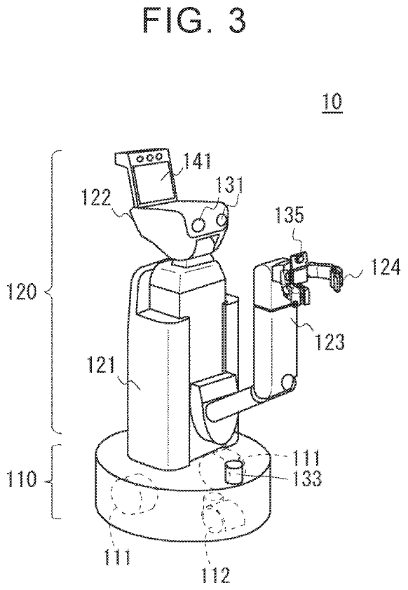

FIG. 3 is an external perspective view illustrating an example of an external configuration of the robot 10 according to the present embodiment. FIG. 3 illustrates an external configuration of the robot 10 including an end effector having a gripping function as an example of the robot 10. The robot 10 is roughly divided into a carriage unit 110 and a main body unit 120. The carriage unit 110 is a movable portion that contributes to the movement of the robot 10 in the traveling direction. The carriage unit 110 supports two drive wheels 111 and one caster 112, each of which is in contact with a traveling surface, in a cylindrical casing. The two drive wheels 111 are arranged so that their rotational axes coincide with each other. Each of the drive wheels 111 is independently rotationally driven by a motor (not shown). The caster 112 is a driven wheel, and is provided such that a pivot shaft extending in the vertical direction from the carriage unit 110 axially supports the wheel away from the rotation shaft of the wheel, and follows the movement direction of the carriage unit 110.

The carriage unit 110 includes a laser scanner 133 at a peripheral portion of the upper surface. The laser scanner 133 scans a certain range in the horizontal plane for each step angle, and outputs whether or not an obstacle exists in each direction. Further, when an obstacle is present, the laser scanner 133 outputs a distance to the obstacle.

The main body unit 120 includes a movable portion that exerts an action different from the movement of the robot 10 in the traveling direction. Specifically, the main body unit 120 mainly includes a trunk portion 121 mounted on the upper surface of the carriage unit 110, a head portion 122 placed on the upper surface of the trunk portion 121, an arm 123 supported on the side surface of the trunk portion 121, and a hand 124 installed at the distal end portion of the arm 123. The arm 123 and the hand 124 are driven via a motor (not shown) to grip an object to be gripped. The trunk portion 121 can be rotated about a vertical axis with respect to the carriage unit 110 by a driving force of a motor (not shown). A hand camera 135 is disposed near the hand 124.

The head portion 122 mainly includes a stereo camera 131 and a display unit 141. The stereo camera 131 has a configuration in which two camera units having the same angle of view are spaced apart from each other, and outputs an imaging signal captured by each camera unit.

The display unit 141 is, for example, a liquid crystal panel, and displays a face of a set character by animation, or displays information related to the robot 10 by text or icons.

The head portion 122 can be rotated about a vertical axis with respect to the trunk portion 121 by a driving force of a motor (not shown). Therefore, the stereo camera 131 can capture an image in an arbitrary direction, and the display unit 141 can present display contents in an arbitrary direction.

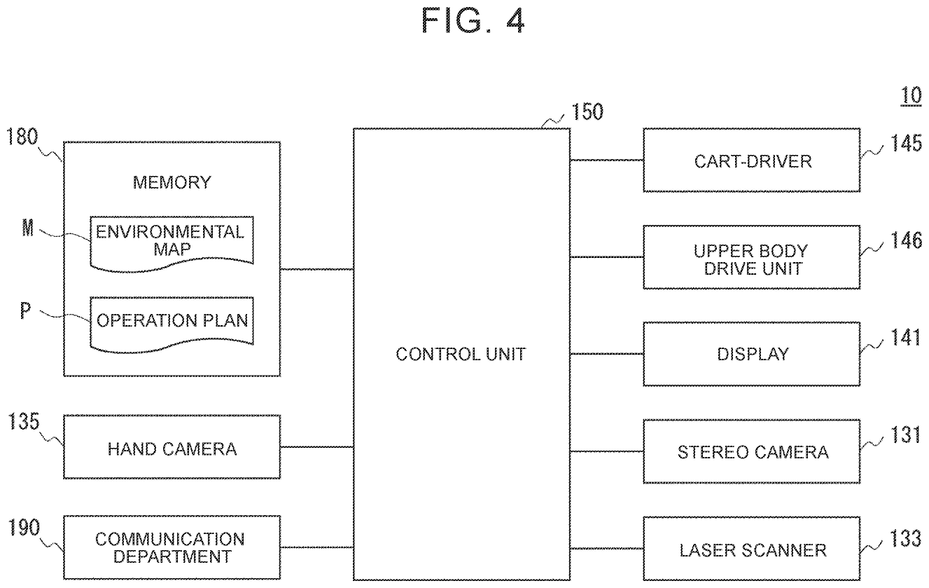

FIG. 4 is a block diagram illustrating a functional configuration of the robot 10 according to the present embodiment. The robot 10 includes a control unit 150, a carriage driving unit 145, an upper body driving unit 146, a display unit 141, a stereo camera 131, a laser scanner 133, a memory 180, a hand camera 135, and a communication unit 190. Note that the upper body driving unit 146, the display unit 141, the stereo camera 131, the laser scanner 133, and the hand camera 135 may be omitted.

The control unit 150 is a processor such as a CPU, and is stored in, for example, a control unit provided in the trunk portion 121. The control unit 150 executes a control program read from the memory 180 to control the entire robot 10 and execute various arithmetic processing.

Here, the control unit 150 executes different controls according to the operation mode. In the present embodiment, the robot 10 has a first mode and a second mode as operation modes. The first mode is a mode in which the control unit 150 controls the carriage drive unit 145 and the upper body drive unit 146 based on the instruction information transmitted by the operation terminal 30. The first mode is also referred to as a normal mode. The second mode is a mode in which the control unit 150 controls the carriage driving unit 145 and the upper body driving unit 146 based on the operation plan generated by itself.

For example, the control unit 150 executes the rotation control of the drive wheels by sending a drive signal to the carriage drive unit 145 in accordance with the instruction information from the operation terminal 30 in the case of the first mode, or in accordance with the latest operation plan P stored in the memory 180 in the case of the second mode. Further, the control unit 150 receives a feedback signal of an encoder or the like from the carriage driving unit 145 and grasps a moving direction and a moving speed of the carriage unit 110.

The carriage driving unit 145 includes a drive wheel 111 and a driving circuit and a motor for driving the drive wheel 111.

The upper body drive unit 146 includes an arm 123 and a hand 124, a trunk portion 121 and a head portion 122, and a drive circuit and a motor for driving these units. The control unit 150 realizes a stretching operation, a gripping operation, and a gesture by sending a drive signal to the upper body drive unit 146. In addition, the control unit 150 receives a feedback signal of an encoder or the like from the upper body drive unit 146, and grasps the position and the moving speed of the arm 123 and the hand 124, the direction and the rotation speed of the trunk portion 121 and the head portion 122.

The display unit 141 receives and displays the image signal generated by the control unit 150.

The stereo camera 131 captures an image of the surrounding environment in which the robot 10 is present in accordance with a request from the control unit 150, and passes an imaging signal to the control unit 150. The control unit 150 executes image processing using the imaging signal, or converts the imaging signal into a captured image in accordance with a predetermined format. The laser scanner 133 detects whether or not an obstacle exists in the moving direction in accordance with a request from the control unit 150, and passes a detection signal, which is a detection result thereof, to the control unit 150.

The hand camera 135 is, for example, a distance image sensor, and is used to recognize a distance, a shape, a direction, and the like of an object to be grasped. The hand camera 135 includes an image sensor in which pixels that photoelectrically convert an optical image incident from a target space are two-dimensionally arranged, and outputs a distance to a subject for each pixel to the control unit 150. Specifically, the hand camera 135 includes an irradiation unit that irradiates the target space with the pattern light, receives the reflected light by the image sensor, and outputs a distance from the distortion and the size of the pattern in the image to the subject captured by each pixel. Note that the control unit 150 grasps the state of a wider surrounding environment by the stereo camera 131, and grasps the state of the vicinity of the grasping object by the hand camera 135.

The memory 180 is a non-volatile storage medium, for example, a solid state drive is used. In addition to the control program for controlling the robot 10, the memory 180 stores various parameter values, functions, look-up tables, and the like used for control and calculation. In particular, the memory 180 stores an environment map M and an operation plan P.

The communication unit 190 is a communication interface with the network N and is, for example, a radio LAN unit. The communication unit 190 receives the instruction information transmitted from the operation terminal 30, and passes the instruction information to the control unit 150. In addition, the communication unit 190 transmits position information and various types of detection results of the robot 10 acquired from a GPS receiver (not shown) to the monitoring terminal 20 and the operation terminal 30 under the control of the control unit 150.

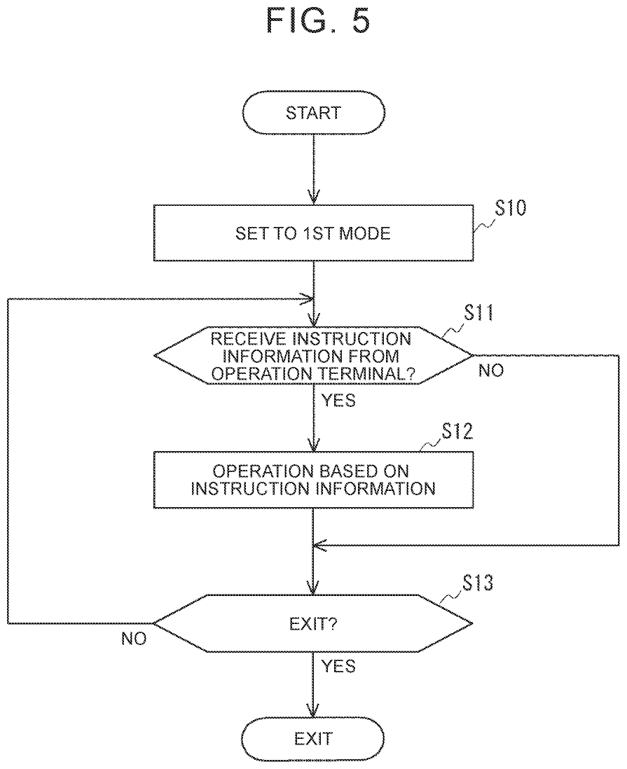

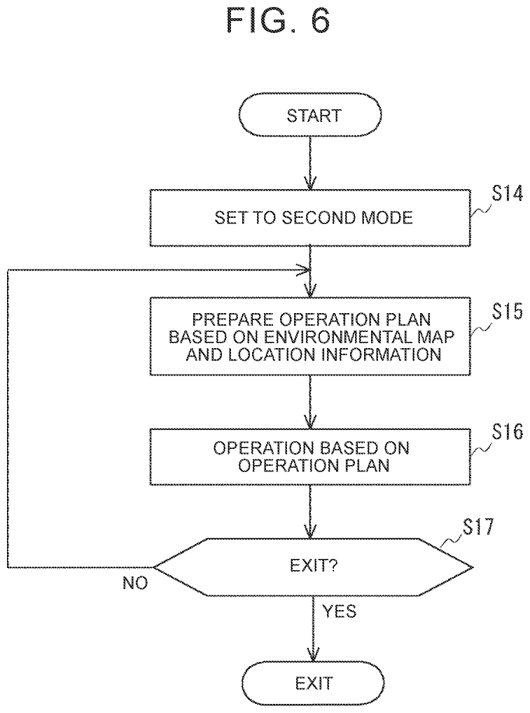

FIG. 5 to FIG. 6 are flowcharts illustrating an example of the operation of the robot 10 according to the present embodiment. FIG. 5 shows an example of the operation when the robot 10 is set to the first mode.

First, when the operation mode is set to the first mode (S10), the control unit 150 determines whether or not instruction data has been received from the operation terminal 30 (S11). When the instruction information is received from the operation terminal 30 (Yes in S11), the control unit 150 controls the carriage driving unit 145 and the upper body driving unit 146 based on the instruction information, and thereby operates the carriage unit 110 and the main body unit 120 of the robot 10 (S12). Then, the control unit 150 advances the process to S13.

On the other hand, if the instruction is not received from the operation terminal 30 (No in S11), the process proceeds to S13 as it is.

In S13, the control unit 150 determines whether or not to terminate the operation. Examples of the case where the operation is terminated include a case where the instruction information for the end of the operation is received from the operation terminal 30 or a case where the power supply of the robot 10 is stopped. The control unit 150 repeats the process shown in S11 to S12 until it is determined that the operation is ended (No in S13).

FIG. 6 shows an example of the operation when the robot 10 is set to the second mode.

First, when the operation mode is set to the second mode (S14), the control unit 150 creates an operation plan P based on the environment map M stored in the memory 180 and its own position information (S15). The control unit 150 stores the created operation plan P in the memory 180. Then, the control unit 150 controls the carriage driving unit 145 and the upper body driving unit 146 based on the operation plan P, and thereby causes the carriage unit 110 and the main body unit 120 of the robot 10 to operate (S16).

Next, the control unit 150 determines whether or not to terminate the operation (S17). The control unit 150 repeats the process shown in S15 to S16 until it is determined that the operation is ended (No in S17).

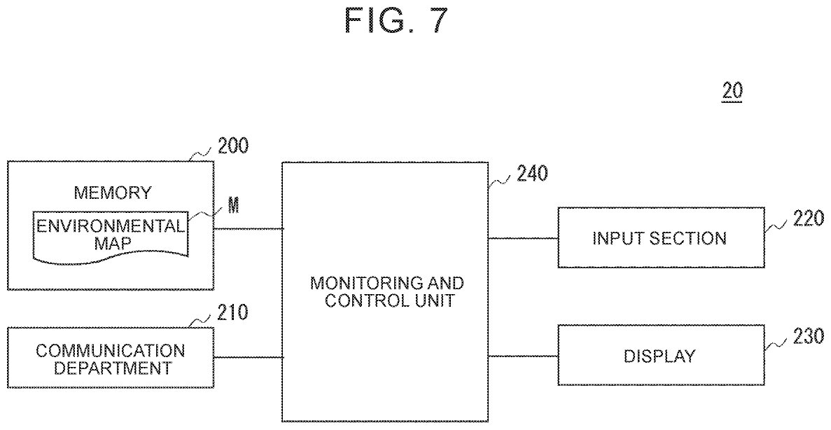

FIG. 7 is a block diagram illustrating a functional configuration of the monitoring terminal 20 according to the present embodiment. The monitoring terminal 20 includes a memory 200, a communication unit 210, an input unit 220, a display unit 230, and a monitoring control unit 240.

The memory 200 is a non-volatile storage medium, for example, a solid state drive is used. In addition to the control program for controlling the monitoring terminal 20, the memory 200 stores various parameter values, functions, look-up tables, and the like used for control and calculation. In particular, the memory 200 stores an environment map M.

The communication unit 210 is a communication interface with the network N. The communication unit 210 receives the position information and various detection results of the robot 10 from the robot 10, and passes them to the monitoring control unit 240 for display. The communication unit 210 may receive instruction information addressed to the robot 10 from the operation terminal 30, and may deliver the instruction information to the monitoring control unit 240 for display. The communication unit 210 transmits the instruction proposal information to the operation terminal 30 in cooperation with the monitoring control unit 240.

The input unit 220 includes a touch panel disposed so as to be superimposed on the display unit 230, a push button provided at a peripheral portion of the display unit 230, and the like. The input unit 220 receives the handwritten input image input by the monitor to designate the content of the instruction to be proposed to the operation terminal 30 by touching the touch panel, and delivers the handwritten input image to the monitoring control unit 240.

The display unit 230 is, for example, a liquid crystal panel, and displays a display image indicating the surrounding environment of the robot 10. The surrounding environment of the robot 10 may be an environment within a predetermined range with respect to the robot 10. The display unit 230 superimposes and displays the input handwritten input image on the display image.

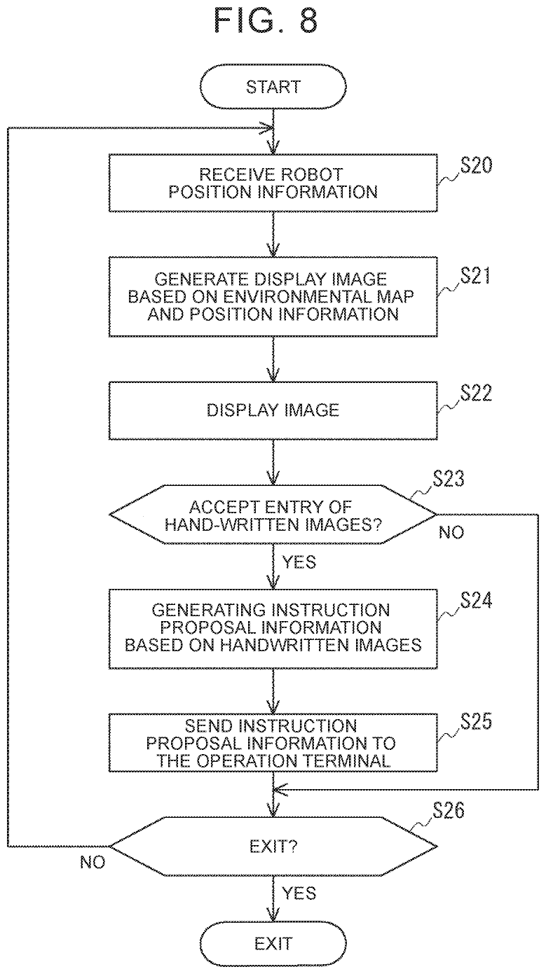

The monitoring control unit 240 is a processor such as a CPU and executes a control program read from the memory 200 to control the entire monitoring terminal 20 and execute various arithmetic processes. A specific control of the monitoring control unit 240 will be described with reference to FIG. 8.

FIG. 8 is a flowchart illustrating an example of the operation of the monitoring terminal 20 according to the present embodiment. First, the monitoring control unit 240 of the monitoring terminal 20 receives position data of the robot 10 from the robot 10 via the communication unit 210 (S20). In addition to the position information, the monitoring control unit 240 may receive various detection results from the robot 10 via the communication unit 210. Further, the monitoring control unit 240 may receive instruction information addressed to the robot 10 from the operation terminal 30 via the communication unit 210.

Next, the monitoring control unit 240 generates displayed images indicating the surrounding environment of the robot 10 on the basis of the environment map M and the position information of the robot 10 stored in the memory 200 (S21). In a case where various detection results of the robot 10 are acquired, the monitoring control unit 240 may further use various detection results as a basis for generating a display image.

Next, the monitoring control unit 240 causes the display unit 230 to display the display images (S22). Next, the monitoring control unit 240 determines whether the input of the handwritten input images has been received from the monitoring person (S23). When the input is received (Yes in S23), the monitoring control unit 240 generates instruction proposal information based on the handwritten input images in response to the input being received (S24).

The instruction proposal information includes the movement direction, the movement amount, or the trajectory of the cart, the arm 123, or the hand 124 of the robot 10, the movement prohibited part of the robot 10, or the position information of the movement destination of the robot 10. In the first embodiment, the instruction proposal information is information including a handwritten input image and an input position on the environment map M. However, when the monitoring control unit 240 has an image recognition function, the instruction proposal information may be information including a recognition result of the handwritten input image and an input position on the environment map M. Alternatively, when the display image displayed on the display unit 230 is synchronized with the display image displayed on the display unit 330 of the operation terminal 30, the instruction proposal information may be the display image on which the handwritten input image is superimposed.

The monitoring control unit 240 transmits the instruction proposal information to the operation terminal 30 via the communication unit 210 (S25).

Next, the monitoring control unit 240 determines whether or not to terminate the series of processes (S26). The case of ending the series of processes includes a case in which the operation of the robot 10 is ended or a case in which the operation mode of the robot 10 is switched to the second mode. The monitoring control unit 240 repeats the processing shown in S20 to S25 until it is determined that the processing is finished (No in S26).

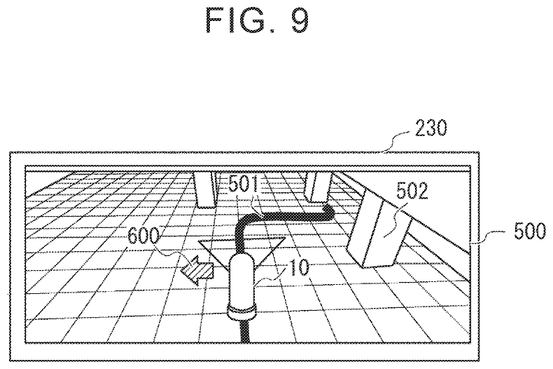

FIG. 9 is a diagram illustrating an example of the handwritten input image 600 according to the present embodiment. The display unit 230 of the monitoring terminal 20 displays a display image 500 indicating the surrounding environment of the robot 10. For example, the display image 500 may include an image area indicating the robot 10 and its surrounding environment as viewed from a predetermined field of view. Although the display image 500 illustrated in FIG. 9 is three-dimensional, the display image 500 may be a two-dimensional image in which the position of the robot 10 is illustrated on the two-dimensional environment map M. Further, the display image may include a movement path 501 of the robot 10 on an image region indicating the surrounding environment. The movement path 501 may be generated based on the instruction information. In addition, an obstacle 502 estimated based on the detection result of the robot 10 may be included in the image region indicating the surrounding environment. Such a display image 500 may be generated by the monitoring control unit 240 by computer graphics.

The monitor inputs the handwritten input image 600 on the displayed display image 500. As a method of inputting a handwritten input image, a user's finger, a touch pen, or the like is used to directly input an input image by touching a corresponding portion on a touch panel. However, the method of inputting the handwritten input image is not limited thereto. For example, the handwritten input image may be input by selecting a predetermined figure using a mouse or the like and specifying a position and a size. The handwritten input image may be input as a two-dimensional line or a figure, or may be input as a three-dimensional object.

In this figure, in order to propose to move the robot 10 to the left, the monitoring person inputs a left arrow figure indicating a moving direction as the handwritten input image 600. The monitoring person may draw a trajectory so as to overwrite the movement path 501. The drawn trajectory is a movement path proposed by the monitoring person. In addition, the monitoring person may designate a moving location of the robot 10 with a marker.

In addition, when the monitoring person wants to propose the movement of the arm 123 or the hand 124 of the robot 10, the display unit 230 may three-dimensionally display the movable region or the movable axis. Then, the monitoring person may designate a moving direction and a moving amount by using a marker. On the contrary, the monitoring person may be allowed to designate the movement prohibition area that should not be moved by the marker.

In this way, by enabling the monitor to intuitively input the handwritten input image, the instruction proposal can be easily given in real time. Further, the suggested instruction is not limited to a predetermined content. Thus, the supervisor can propose dynamic and flexible instructions.

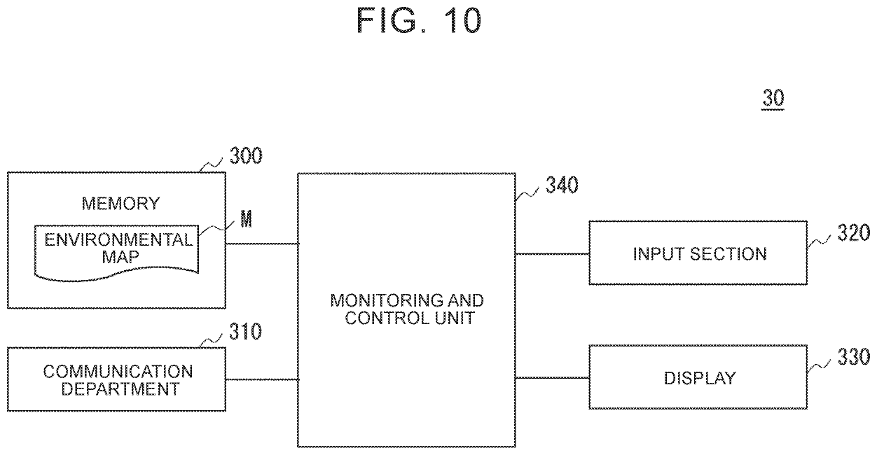

FIG. 10 is a block diagram illustrating a functional configuration of the operation terminal 30 according to the present embodiment. The operation terminal 30 includes a memory 300, a communication unit 310, an input unit 320, a display unit 330, and an operation control unit 340.

The memory 300 is a non-volatile storage medium, for example, a solid state drive is used. In addition to the control program for controlling the operation terminal 30, the memory 300 stores various parameter values, functions, look-up tables, and the like used for control and calculation. In particular, the memory 300 stores an environment map M.

The communication unit 310 is a communication interface with the network N. The communication unit 310 receives the position information and various detection results of the robot 10 from the robot 10, and passes them to the operation control unit 340. The communication unit 310 receives the instruction proposal information from the monitoring terminal 20, and passes the instruction proposal information to the operation control unit 340. The communication unit 310 transmits instruction information to the robot 10 in cooperation with the operation control unit 340.

The input unit 320 includes a mouse, a keyboard, a joystick, a touch panel disposed so as to be superimposed on the display unit 330, a push button provided at a peripheral portion of the display unit 330, and the like. The input unit 320 receives input of instruction information to the robot 10 by the operator clicking a mouse, inputting a command, touching a touch panel, or tilting a lever of a joystick, and passes the input to the operation control unit 340.

The display unit 330 is, for example, a liquid crystal panel, and displays a display image indicating the surrounding environment of the robot 10. When the instruction proposal information is received, the display unit 330 displays a display image further including the received instruction proposal information. The display unit 330 superimposes and displays the instruction information input from the operator on the display image.

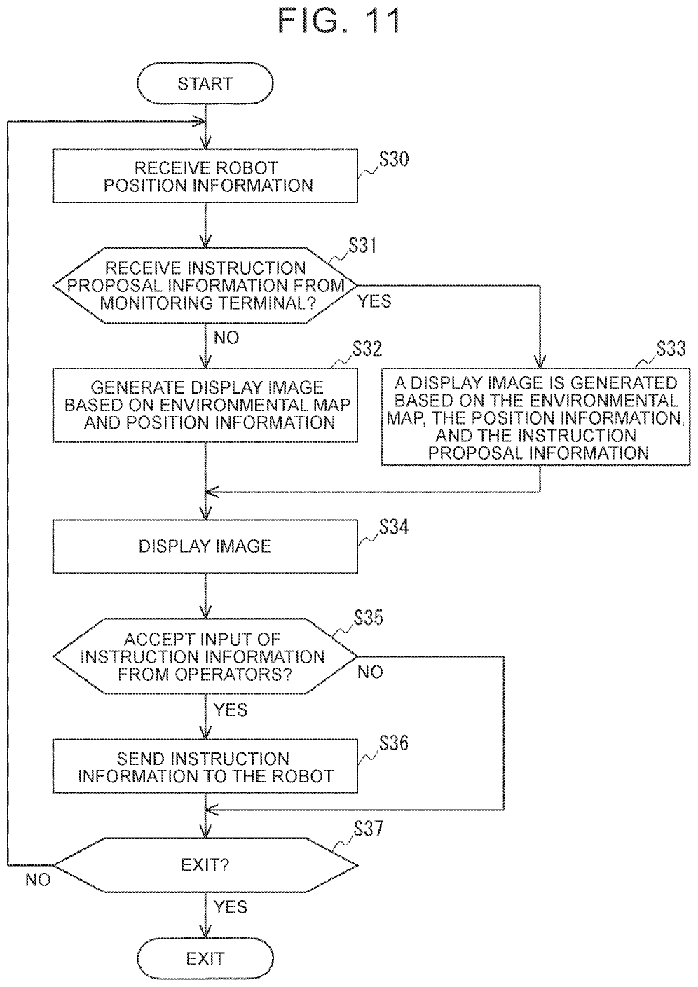

The operation control unit 340 is a processor such as a CPU and executes a control program read from the memory 300 to control the entire operation terminal 30 and perform various arithmetic operations. A specific control of the operation control unit 340 will be described with reference to FIG. 11.

FIG. 11 is a flowchart illustrating an example of the operation of the operation terminal 30 according to the present embodiment. The operation terminal 30 may operate when the robot 10 is set to the first mode.

First, the operation control unit 340 of the operation terminal 30 receives position information of the robot 10 from the robot 10 via the communication unit 310 (S30). Next, the operation control unit 340 determines whether or not instruction proposal information has been received from the monitoring terminal 20 via the communication unit 310 (S31).

When the instruction proposal information is not received from the monitoring terminal 20 (No in S31), the operation control unit 340 generates a display image indicating the surrounding environment of the robot 10 based on the environment map M and the position information of the robot 10 stored in the memory 300 (S32). The method of generating the display image may be the same in part or all as the method of generating the display image displayed on the display unit 230 of the monitoring terminal 20. The operation control unit 340 advances the process to S34.

On the other hand, when the instruction proposal information is received from the monitoring terminal 20 (Yes in S31), the operation control unit 340 generates a displayed image based on the environment map M, the instruction proposal information, and the position information of the robot 10 in response to the reception (S33). The display image is an image in which an instruction proposal is visually displayed in the surrounding environment of the robot 10. The operation control unit 340 advances the process to S34.

In S34, the operation control unit 340 causes the display unit 330 to display the display images generated by S32 or S33.

Then, the operation control unit 340 determines whether the input unit 320 has received the input of the instruction information from the operator (S35). When the input is accepted (Yes in S35), the instruction information is transmitted to the robot 10 via the communication unit 310 in response to the acceptance of the input (S36). Then, the operation control unit 340 advances the process to S37. On the other hand, if there is no entry (No in S35), the operation control unit 340 advances the process to S37 as it is.

Next, the operation control unit 340 determines whether or not to end the series of processes (S37). The case of ending the series of processes includes a case in which the operation of the robot 10 is ended or a case in which the operation mode of the robot 10 is switched to the second mode. The operation control unit 340 repeats the processing shown in S30 to S36 until it is determined that the processing is finished (No in S37).

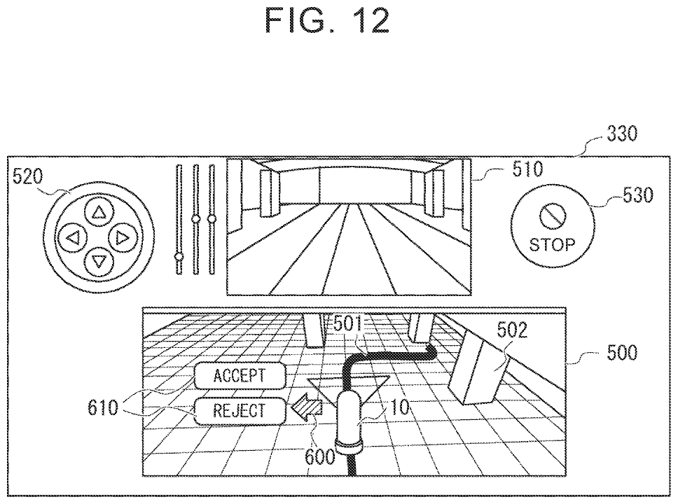

FIG. 12 is a diagram illustrating an example of the display of the display unit 330 according to the present embodiment. The display unit 330 of the operation terminal 30 displays a display image 500 indicating the surrounding environment of the robot 10. The display unit 330 displays a captured image 510 captured by the stereo camera 131 of the robot 10. The display image 500 and the captured image 510 allow the operator to grasp the surrounding environment of the robot 10.

The display unit 330 displays an operation unit 520,530 for giving an operation instruction to the robot 10. Thus, the operator can specifically specify the operation direction, the movement amount, and the like of the robot 10.

When the operation terminal 30 receives the instruction proposal information, the display unit 330 superimposes the handwritten input image 600 on the display image 500 as the instruction proposal information. The display unit 330 may reproduce the trajectory of the carriage unit 110 or the arm 123 when the instruction proposal information includes the trajectory.

Then, the display unit 330 displays, on the display image 500, an option 610 relating to the adoptability of the proposal indicated by the instruction proposal information. The display may be pop-up.

The operator who has browsed the display confirms the surrounding environment indicated by the instruction proposal information, and confirms the safety of the operation in the direction indicated by the instruction proposal information by, for example, causing the robot 10 to operate in the direction indicated by the instruction proposal information little by little.

The operator then selects the “ACCEPT” or “REJECT” option 610. Accordingly, the input unit 320 receives, from the operator, a selection of whether or not to adopt the instruction proposal information. In response to receiving the selection, the operation control unit 340 transmits instruction information corresponding to the selected option to the robot 10 via the communication unit 310.

By displaying the instruction proposal in an easy-to-understand manner as described above, the operator can easily grasp the proposal content. Since the instruction proposal information is visually displayed, the conversation is not disturbed even when the operator is talking with a person facing the robot 10 via the robot 10. Further, the operator can easily adopt the operation proposed by the monitoring terminal 20 in a one-click manner. Therefore, the robot 10 can quickly perform the operation proposed by the monitoring terminal 20.

The embodiments have been described above. According to the present embodiment, an instruction is proposed after a monitoring person having a field of view different from that of the robot 10 grasps, through the monitoring terminal 20, a situation that cannot be recognized from the field of view of the robot or a situation that the operator cannot recognize even based on the map information, that is, a situation that is unexpected or unrecognized in the system. Therefore, the operator can instruct the robot 10 to perform an operation in consideration of an unexpected or unrecognized situation of the system. Thus, the robot can operate in consideration of an unexpected or unrecognized situation of the system.

It should be noted that the following modifications can be made to the embodiments.

### 1 Modification of the Embodiment

In the first modification, in a case where the operation terminal 30 does not respond in spite of the instruction proposed by the monitoring terminal 20, the robot 10 performs an autonomous operation. Specifically, when the operation terminal 30 does not transmit the instruction information within a predetermined time after the monitoring terminal 20 transmits the instruction proposal information, the robot 10 switches the operation mode from the first mode to the second mode. In this case, when the monitoring terminal 20 transmits the instruction proposal information to the operation terminal 30, the instruction proposal information may also be transmitted to the robot 10. Note that the second mode switched in the above-described case may be referred to as an intervention mode. In the intervention mode, even if the operation terminal 30 transmits the instruction information to the robot 10, the robot 10 may autonomously operate regardless of the instruction information.

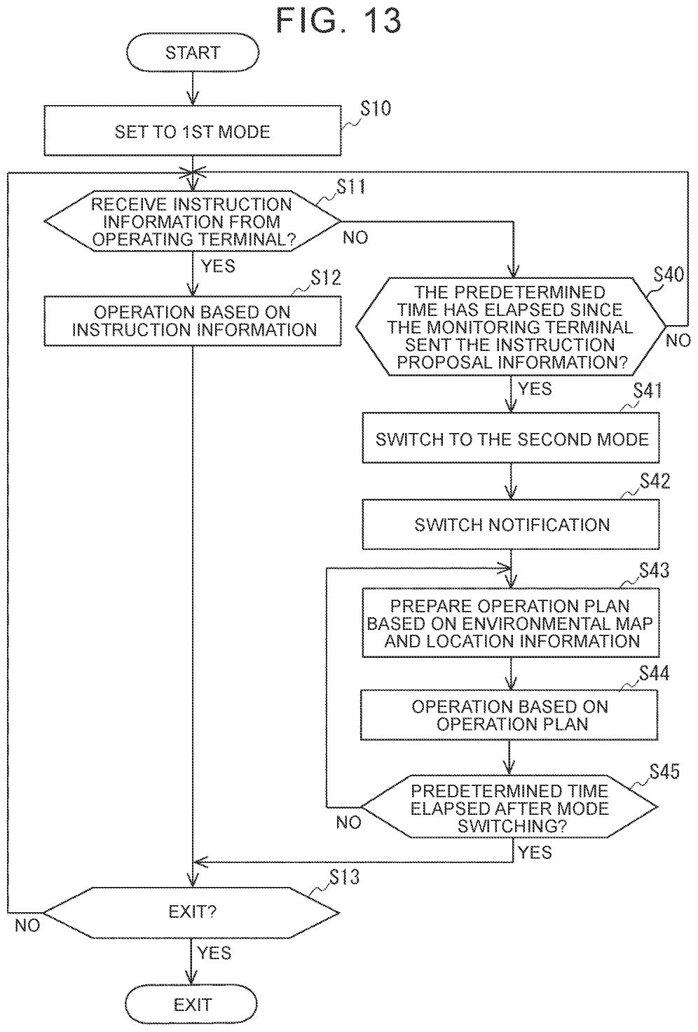

FIG. 13 is a flowchart illustrating an example of the operation of the robot 10 according to the first modification of the present embodiment. The steps shown in FIG. 13 have a S40 to S45 in addition to the steps shown in FIG. 5.

When it is determined in S11 that the instruction information has not been received from the operation terminal 30 (No in S11), the control unit 150 determines whether or not a predetermined period has elapsed since the monitoring terminal 20 transmitted the instruction suggestion information (S40). When the predetermined period has not elapsed (No in S40), the control unit 150 returns the process to S11. On the other hand, when a predetermined period of time has elapsed (Yes in S40), the control unit 150 switches the operation mode to the second mode (S41). Then, the control unit 150 notifies the operation terminal 30 of the switching to the second mode via the communication unit 190 (S42).

In response to the switching to the second mode, the control unit 150 executes the same S43 to S44 as S15 to S16 in FIG. 6, and operates the carriage unit 110 and the main body unit 120 based on the motion planning created by itself.

Then, the control unit 150 repeats S43 to S44 until a predetermined time has elapsed from the switching to the second mode (No in S45), and when a predetermined time has elapsed (Yes in S45), the control unit cancels the second mode and advances the process to S13.

In this way, even when the operator is not aware of the instruction proposal or when the operator takes time to make a decision, the danger can be avoided by flexibly coping with the instruction proposal in the field.

Note that the display unit 330 of the operation terminal 30 may superimpose and display the mode information on the display image in response to the switching of the robot 10 to the second mode, that is, in response to receiving the switching notification. Thus, the operator can immediately grasp that the robot 10 has shifted to the second mode, and the operator can take appropriate action.

### 2 Modification of the Embodiment

In the second modification, when the operation terminal 30 despite the monitoring terminal 20 has proposed an instruction is not responded, the robot 10 switches to the third mode to operate according to an instruction of the monitoring terminal 20. Specifically, when the operation terminal 30 does not transmit the instruction information within a predetermined time after the monitoring terminal 20 transmits the instruction proposal information, the robot 10 switches the operation mode from the first mode to the third mode. In the third mode, the monitoring terminal 20 transmits the instruction information to the robot 10 in response to receiving the input of the instruction information from the monitor. The third mode switched in the above-described case may be referred to as an intervention mode. In the intervention mode, even if the operation terminal 30 transmits the instruction information to the robot 10, the robot 10 may operate based on the instruction information from the monitoring terminal 20.

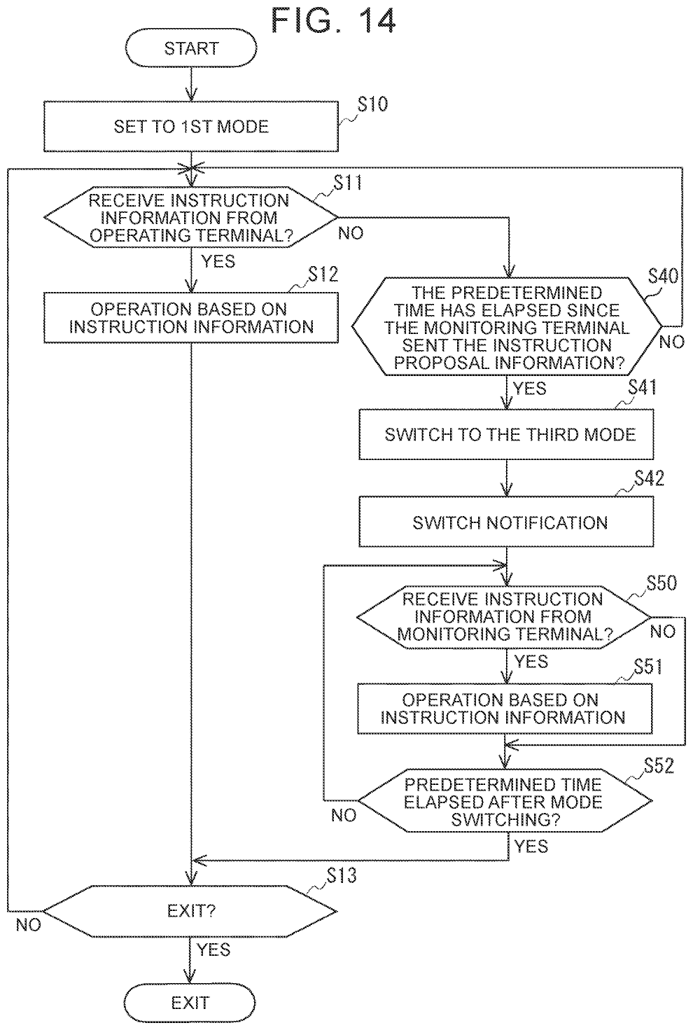

FIG. 14 is a flowchart illustrating an example of the operation of the robot 10 according to the second modification of the present embodiment. The steps shown in FIG. 14 have S50 to S52 instead of S43 to S45 shown in FIG. 13.

The control unit 150 determines whether the instruction data is received from the monitoring terminal 20 in response to the notification of the switching to the third mode to the operation terminal 30 (S50). When the instruction information is received from the monitoring terminal 20 (Yes in S50), the control unit 150 operates the carriage unit 110 and the main body unit 120 based on the instruction information (S51), and advances the process to S52. On the other hand, if the instruction is not received from the monitoring terminal 20 (No in S50), the process proceeds to S52 as it is.

Then, the control unit 150 repeats S50 to S51 until a predetermined time elapses from the switching to the third mode (No in S52), and when a predetermined time elapses (Yes in the S52), cancels the third mode and advances the process to S13. When the operator is not aware of the instruction proposal or when the operator takes time to make a decision, the operator can flexibly respond to the danger by the judgment of the monitoring person at the site and avoid the danger.

Note that the display unit 330 of the operation terminal 30 may superimpose and display the mode information on the display image in response to the switching of the robot 10 to the third mode, that is, in response to receiving the switching notification. Thus, the operator can immediately grasp that the robot 10 has shifted to the third mode, and the operator can take appropriate action.

The present disclosure is not limited to the above-described embodiment, and can be appropriately modified without departing from the scope of the present disclosure. For example, in the present embodiment, the operation terminal 30 determines whether or not to adopt the instruction proposal information from the monitoring terminal 20, and gives an operation instruction to the robot 10 based on the determination. However, the robot 10 may operate based on the instruction proposal information when the instruction proposal information is received from the monitoring terminal 20 before the instruction information is received from the operation terminal 30, and the operation terminal 30 may confirm the operation based on the instruction proposal information later. In this case, the operation terminal 30 transmits, to the robot 10, the instruction information including information indicating that the instruction information has been ratified.

Further, in the present embodiment, the monitoring terminal 20 is carried by the monitor, but the monitoring terminal 20 is not carried by the monitor, and may be installed in a moving body such as a drone. In this case, the operator of the mobile object may be a supervisor. In addition, the monitoring terminal 20 may be installed at a plurality of locations within the mobile area of the robot 10. The monitoring terminal 20 around the robot 10 may take an image of the surrounding environment of the robot 10 from an angle different from that of the robot 10, and may transmit the instruction proposal information to the operation terminal 30 in a case where the danger is predicted by image recognition.

In addition, in the present embodiment, the monitoring person inputs a handwritten input image, but it is not necessary to perform handwriting.

In the first or second modification, the robot 10 shifts to the second mode or the third mode when the operation terminal 30 does not transmit the instruction information within a predetermined time after the monitoring terminal 20 transmits the instruction proposal information. However, the robot 10 may switch to the second mode or the third mode when a request to switch the operation mode is received from the operation terminal 30. In this case, a help mark is displayed on the display unit 330 of the operation terminal 30, and the operation terminal 30 may transmit a request for switching the operation mode to the robot 10 in response to the operator selecting the help mark.

What is claimed is:

1. A remote operation system comprising an operation terminal, wherein the operation terminal
generates a display image at least based on instruction proposal information and a position of a robot in response to receiving the instruction proposal information from a monitoring terminal located in a predetermined range based on the robot, the instruction proposal information being information for proposing an instruction of operation of the robot,
displays the display image, and
transmits instruction information to the robot in response to receiving an input of the instruction information from an operator, the instruction information being information for instructing the robot about the operation.

2. The remote operation system according to claim 1, wherein the operation terminal
superimposes and displays, on the display image, an option on whether to adopt a proposal indicated by the instruction proposal information,
receives a selection on whether to adopt the instruction proposal information, and
transmits the instruction information corresponding to the selection to the robot.

3. The remote operation system according to claim 1, further comprising the monitoring terminal, wherein in response to receiving, from a monitoring person, an input of a handwritten input image with respect to an image indicating a surrounding environment of the robot, the monitoring terminal generates the instruction proposal information based on the handwritten input image and transmits the instruction proposal information to the operation terminal.

4. The remote operation system according to claim 1, further comprising the robot, wherein the robot
includes a normal mode and an intervention mode as an operation mode, a normal mode being a mode in which the robot operates based on the instruction information received from the operation terminal, and the intervention mode being a mode in which the robot operates based on an operation plan generated by the robot or the instruction information received from the monitoring terminal, and
switches the operation mode from the normal mode to the intervention mode when the robot does not receive the instruction information from the operation terminal within a predetermined time after the monitoring terminal transmits the instruction proposal information.

5. The remote operation system according to claim 4, further comprising the monitoring terminal, wherein in response to receiving an input of the instruction information from a monitoring person in the intervention mode, the monitoring terminal transmits the instruction information to the robot.

6. The remote operation system according to claim 4, wherein the operation terminal superimposes and displays mode information on the display image in response to switching of the robot to the intervention mode.

7. A remote operation method comprising:
generating a display image at least based on instruction proposal information and a position of a robot in response to receiving the instruction proposal information from a monitoring terminal located in a predetermined range based on the robot, the instruction proposal information being information for proposing an instruction of operation of the robot;
displaying the display image; and
transmitting instruction information to the robot in response to receiving an input of the instruction information from an operator, the instruction information being information for instructing the robot about the operation.

8. A non-transitory storage medium storing a program causing a computer to achieve:
generating a display image at least based on instruction proposal information and a position of a robot in response to receiving the instruction proposal information from a monitoring terminal located in a predetermined range based on the robot, the instruction proposal information being information for proposing an instruction of operation of the robot;
displaying the display image; and
transmitting instruction information to the robot in response to receiving an input of the instruction information from an operator, the instruction information being information for instructing the robot about the operation.
